(19) United States
(12) Patent Application Publication
(10) Pub. No.: US 2015/0194272 A1
(43) Pub. Date: Jul. 9, 2015

(54) DYE-SENSITIZED SOLAR CELL AND METHOD OF MANUFACTURING THE SAME

(71) Applicant: Electronics and Telecommunications Research Institute, Daejeon (KR)

(72) Inventor: Moo Jung CHU, Daejeon (KR)

(73) Assignee: Electronics and Telecommunications Research Institute, Daejeon (KR)

(21) Appl. No.: 14/341,526

(22) Filed: Jul. 25, 2014

(30) Foreign Application Priority Data
Jan. 9, 2014 (KR) 10-2014-0002917

(51) Int. Cl. H01G 9/20; H01G 9/00

(52) U.S. Cl. CPC H01G 9/2077; H01G 9/0029

(57) ABSTRACT

Provided are a dye-sensitized solar cell and a method of manufacturing the same. The dye-sensitized solar cell includes a lower substrate, an upper substrate opposite to the lower substrate, an electrolyte between the upper substrate and the lower substrate, a sealing member surrounding edges of the upper substrate and the lower substrate and including a plurality of openings for providing a space between the upper substrate and the lower substrate with the electrolyte, and a plurality of plugs inserted in the openings.

### CROSS-REFERENCE TO RELATED APPLICATIONS

This U.S. non-provisional patent application claims priority under 35 U.S.C. §119 of Korean Patent Application No. 10-2014-0002917, filed on Jan. 9, 2014, the entire contents of which are hereby incorporated by reference.

### BACKGROUND OF THE INVENTION

The present invention disclosed herein relates to a solar cell and a method of manufacturing the solar cell, and more particularly, to a dye-sensitized solar cell and a method of manufacturing the dye-sensitized solar cell.

Recently, in order to overcome fossil energy exhaustion, environmental destruction, and climate change, researches for using renewable energy have been actively performed. Particularly, solar cells using solar energy, which is an unlimited and echo-friendly energy source, have been vigorously developed.

For example, dye-sensitized solar cells were developed by Michael Gratzel research team in 1990s. Due to properties of more transmitting light than semiconductor solar cells, dye-sensitized solar cells may be used in various fields and can be manufactured at low prices. Dye-sensitized solar cells may absorb visible rays using a different mechanism from silicon solar cells. Dye-sensitized solar cells are photoelectrochemical solar cells formed of photosensitive dye molecules capable of forming pairs of electron-hole, nanoparticles of dioxide titanium transferring generated electrons, and an electrolyte helping electrons in oxidation-reduction.

Dye-sensitized solar cells may include a sealing member sealing an electrolyte between an upper substrate and a lower substrate. The sealing member may include a plurality of openings, into which the electrolyte is injected. The plurality of openings may be disposed on both sides of cells. The electrolyte may be injected through the plurality of openings.

The openings may be sealed by an encapsulating member. However, the encapsulating member may be deteriorated in adhesion durability due to pollution caused by impurities such as an electrolyte attached to inner walls of the openings. Due thereto, as time passes, a leakage of the electrolyte occurs, thereby reducing a life of cells. As a method for overcoming this, openings may be cleaned after being primarily sealed by a provisional encapsulant. Also, after cleaning, the openings may be secondarily sealed by finishing materials. However, a process of doubly using a provisional encapsulant and finishing materials may cause an increase in manufacturing costs for dye-sensitized solar cells and may decrease productivity.

### SUMMARY OF THE INVENTION

The present invention provides dye-sensitized solar cells capable of improving durability, productivity, and production yield and a method of manufacturing the dye-sensitized solar cells.

Embodiments of the inventive concept provide dye-sensitized solar cells including a lower substrate, an upper substrate opposite to the lower substrate, an electrolyte between the upper substrate and the lower substrate, a sealing member surrounding edges of the upper substrate and the lower substrate and including a plurality of openings that the electrolyte is provided in a space between the upper substrate and the lower substrate, and a plurality of plugs inserted in the openings, in which the openings include at least one fluid injection path disposed at a first side of the upper substrate and the lower substrate and an air discharge passage disposed at a second side of the upper substrate and the lower substrate opposite to the fluid injection path, the air discharge passage including at least one inlet formed on an inner wall of the sealing member and a plurality of outlets branching off from the inlet in the sealing member, the plurality of outlets formed on an outer wall of the sealing member.

In some embodiments, the air discharge passage may have a Y shape.

In other embodiments, the plugs may include a first plug disposed in the fluid injection path and a second plug disposed in the air discharge passage.

In still other embodiments, the second plug may connect one to another of the plurality of outlets of the air discharge passage having the Y shape.

In even other embodiments, the second plug may have a V shape.

In yet other embodiments, the electrolyte may be disposed from the inlet to a branch point of the air discharge passage having the Y shape.

In further embodiments, the air discharge passage between the plurality of outlets and the branch point may be bent.

In still further embodiments, the air discharge passage from the plurality of outlets to the branch point may be bent.

In even further embodiments, the plurality of outlets may be disposed near one of the edges of the upper substrate and the lower substrate and the inlet may be disposed near another of the edges of the upper substrate and the lower substrate.

In yet further embodiments, the air discharge passage between the plurality of outlets may be bent as a curly bracket ({).

In much further embodiments, the plurality of outlets may be disposed near both edges of the upper substrate and the lower substrate, respectively.

In still much further embodiments, the plurality of plugs may be connected in the air discharge passage between the plurality of outlets.

In even much further embodiments, the fluid injection path may be bent once, twice, three times and more than that.

In other embodiments of the inventive concept, methods of manufacturing a dye-sensitized solar cell include forming a lower electrode on a lower substrate, forming an upper electrode on an upper substrate opposite to the lower substrate, forming a sealing member including a fluid injection path and an air discharge passage on edges of the upper substrate and the lower substrate to bond the upper substrate to the lower substrate, providing a fluid comprising dye and an electrolyte in a space between the upper substrate and the lower substrate, and forming a first plug and a second plug in the fluid injection path and the air discharge passage, respectively, in which the air discharge passage includes at least one inlet formed on an inner wall of the sealing member and a plurality of outlets branching off from the inlet in the sealing member, the plurality of outlets formed on an outer wall of the sealing member, and the second plug is injected from one to another of the plurality of outlets.

In some embodiments, the sealing member may include glass frit and may be cured by heat treatment after bonding the upper substrate to the lower substrate.

In other embodiments, the first plug and the second plug may include epoxy resin. The second plug may be provided to the air discharge passage after the first plug is cured.

### BRIEF DESCRIPTION OF THE DRAWINGS

The accompanying drawings are included to provide a further understanding of the present invention, and are incorporated in and constitute a part of this specification. The drawings illustrate exemplary embodiments of the inventive concept and, together with the description, serve to explain principles of the present invention. In the drawings:

FIG. 1 is a top view of a dye-sensitized solar cell according to an embodiment of the inventive concept;

FIG. 2 is a cross-sectional view illustrating a part taken along a line I-I′ of FIG. 1;

FIG. 3 is a top view of a dye-sensitized solar cell according to a first example of the embodiment;

FIG. 4 is a top view of a dye-sensitized solar cell according to a second example of the embodiment;

FIGS. 5 and 6 are top views of dye-sensitized solar cells according to third and fourth examples of the embodiment; and

FIGS. 7 to 12 are cross-sectional views and top views sequentially illustrating a method of manufacturing the dye-sensitized solar cell of FIG. 1.

### DETAILED DESCRIPTION OF PREFERRED EMBODIMENTS

Hereinafter, exemplary embodiments of the inventive concept will be described in detail with reference to the attached drawings. Advantages and features of the inventive concept and a method of achieving the same will be specified with reference to the embodiments that will be described together with the attached drawings. However, the present invention is not limited to the embodiments described below and may have variously modified forms. The embodiments that will be described hereafter are provided to allow the disclosure to be thoroughgoing and perfect and to allow a person of ordinary skills in the art to fully understand the scope of the present invention. The present invention will be defined only by the scope of following claims. Throughout the entire specification, like reference numerals designate like elements.

Terms used in the specification are to describe the embodiments but not to limit the scope of the present invention. As used herein, the singular forms are intended to include the plural forms as well, unless the context clearly indicates otherwise. It will be further understood that the terms “comprises” and/or “comprising” used herein specify the presence of stated features or components, but do not preclude the presence or addition of one or more other features or components. Also, as just exemplary embodiments, reference numerals shown according to an order of description are not limited thereto.

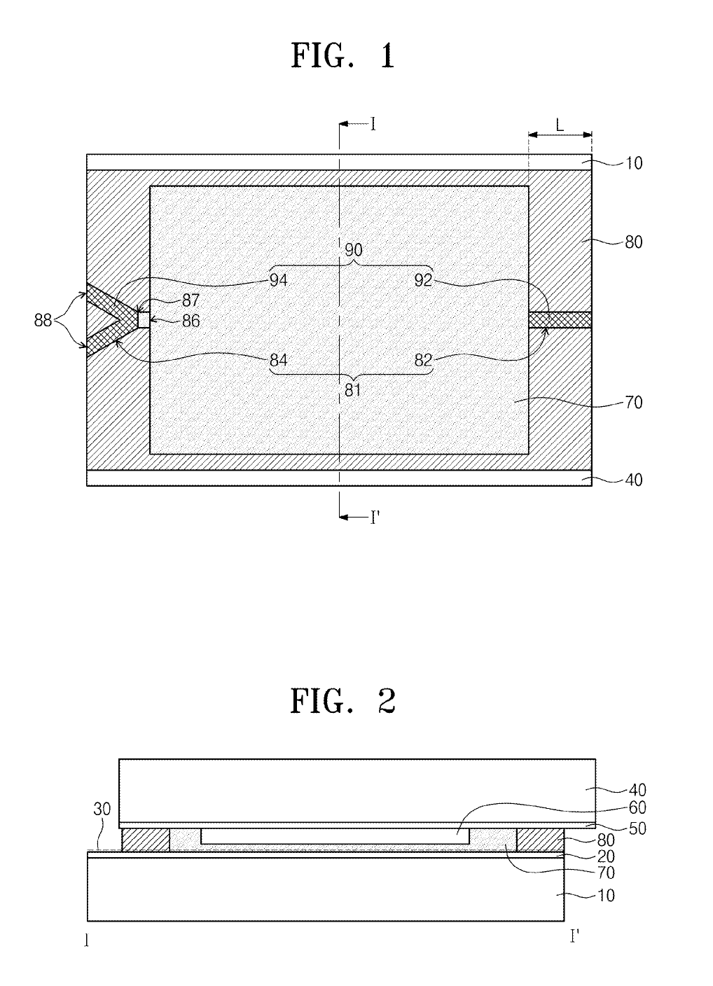

FIG. 1 is a top view of a dye-sensitized solar cell according to an embodiment of the inventive concept. FIG. 2 is a cross-sectional view illustrating a part taken along a line I-I′ of FIG. 1.

Referring to FIGS. 1 and 2, the dye-sensitized solar cell may include a lower substrate 10, a lower electrode 20, a catalytic layer 30, an upper substrate 40, an upper electrode 50, a dye layer 60, a sealing member 80, and plugs 90.

The lower substrate 10 may include a transparent material such as glass and plastic.

The lower electrode 20 may be disposed on the lower substrate 10. The lower electrode 20 may be a transparent electrode such as an indium tin oxide (ITO) electrode.

The catalytic layer 30 may be disposed on the lower electrode 20. The catalytic layer 30 may catalyze an oxidation-reduction reaction between the electrolyte 70 and dye molecules (not shown). The catalytic layer 30 may include a metal layer.

The upper substrate 40 may be disposed on the lower substrate 10. The upper substrate 40 may be separate from the lower substrate 10. The upper substrate 40 may include a transparent substrate such as glass and plastic.

The upper electrode 50 may be disposed on the upper substrate 40. The upper electrode 50 may be a transparent electrode such as an ITO electrode.

The metal oxide layer 60 may be disposed on the upper electrode 50. The metal oxide layer 60 may include nano-sized dioxide titanium (TiO₂). The metal oxide layer 60 may adsorb dye molecules. The dye molecules may absorb photon penetrating the metal oxide layer 60, thereby generating excited electrons. Herein, the dye molecules may be oxidized. The excited electrons are injected into the catalytic layer 30 and are transferred to an external circuit (not shown) through the lower electrode 20. After that, the electrons may be may be transferred to the upper electrode 50.

The electrolyte 70 may be disposed between the lower substrate 10 and the upper substrate 40. The dye molecules may be dissolved in the electrolyte 70. The metal oxide layer 60 may be dipped into the electrolyte 70. The electrolyte 70 may include an iodine solution. The iodine solution may include an oxidation-reduction pair of iodine ions I⁻ and oxidized iodine ions I³⁻. The oxidized dye molecules may receive electrons from the oxidation-reduction pair of iodine ions I⁻ in the electrolyte 70, thereby being reduced to dye molecules. The oxidized iodine ions I³⁻ in the electrolyte 70 may be coupled with electrons arriving in the upper electrode 50 and may infinitely repeat oxidation-reduction reactions.

The sealing member 80 may bond the lower substrate 10 to the upper substrate 40. The lower substrate 10 and the upper substrate 40 may be separate from each other by the sealing member 80. The sealing member 80 may surround edges of the lower substrate 10 to the upper substrate 40. The sealing member 80 may seal the electrolyte 70. The sealing member 80 may prevent the electrolyte 70 from being polluted. The sealing member 80 may include glass frit. The sealing member 80 may include a plurality of openings 81.

The openings 81 may include a fluid injection path 82 and an air discharge passage 84. The fluid injection path 82 may be disposed on one of the edges of the lower substrate 10 and the upper substrate 40. The fluid injection path 82 may be a path for supplying the electrolyte 70.

The air discharge passage 84 may be disposed on other sides of the edges of the lower substrate 10 and the upper substrate 40. The air discharge passage 84 may be a passage for discharging the air in the sealing member 80 between the lower substrate 10 and the upper substrate 40. The air discharge passage 84 may have a Y shape. Herein, the air discharge passage 84 having the Y shape may be disposed horizontally or vertically to the lower substrate 10 and the upper substrate 40. The air discharge passage 84 having the Y shape in FIG. 1 is disposed horizontally. However, the air discharge passage 84 is not limited thereto and may be variously modified.

The plugs 90 may be fastened into the openings 81 of the sealing member 80. The plugs 90 may prevent a leakage of the electrolyte 70 in the openings 81. The plugs 90 may include a first plug 92 and a second plug 94. The first plug 92 may be disposed in the fluid injection path 82. The second plug 94 may be disposed in the air discharge passage 84. The plugs 90 may include epoxy resin.

As a length L of the fluid injection path 82 more increases, the leakage of the electrolyte 70 may less occur. For example, when a probability of the leakage of the electrolyte 70 per a unit length L′ of the fluid injection path 82 is A′, a probability A of the leakage occurring when the length of the fluid injection path 82 is L is given as A^{L/L′}. As an example, when the probability of the leakage per the unit length L′ of the fluid injection path 82 is supposed as 0.1, the probability of the leakage may be 0.1²=0.01 when the length of the fluid injection path 82 is two times longer than the unit length. Accordingly, when the length of the fluid injection path increases in the same condition, the probability of the leakage may be reduced.

The air discharge passage 84 may include a single inlet 86 and a plurality of outlets 88. The air discharge passage 84 may be divided into the single inlet 86 and the plurality of outlets 88. The electrolyte 70 and the second plug 94 may be disposed in the air discharge passage 84.

The single inlet 86 may be disposed on an inner wall of the sealing member 80. The electrolyte 70 may be disposed in the single inlet 86. From the single inlet 86 to a branch point 87 of the air discharge passage 84 having a neck may be filled with the electrolyte 70.

The plurality of outlets 88 may be disposed on an outer wall of the sealing member 80. The second plug 94 may be disposed in the plurality of outlets 88. The second plug 94 may be disposed between the outlets 88 of the air discharge passage 84. The second plug 94 may have a box shape connecting one to another of the outlets 88. The second plug 94 may effectively prevent the leakage of the electrolyte 70 in the branch point 87 of the air discharge passage 84.

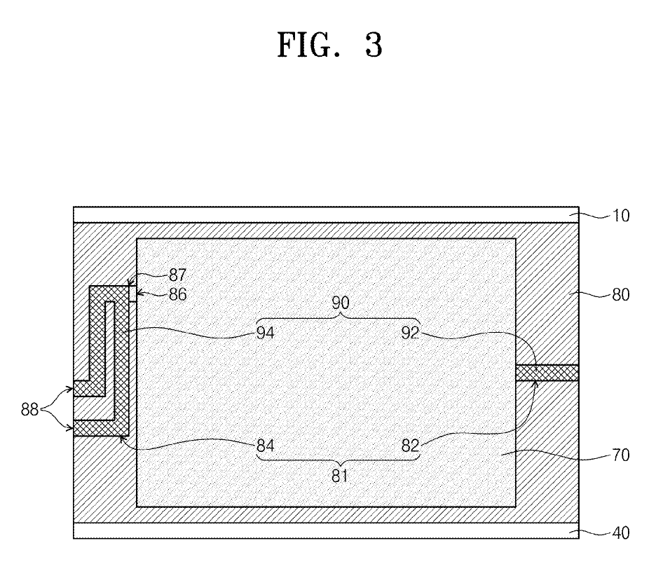

FIG. 3 is a top view of a dye-sensitized solar cell according to a first example of the embodiment;

Referring to FIG. 3, the dye-sensitized solar cell may include the sealing member 80 including the plurality of outlets 88 adjacent to one of the upper substrate 40 and the lower substrate 10 and the single inlet 86 adjacent to the other sides of the edges of the upper substrate 40 and the lower substrate 10. The air discharge passage 84 may be bent between the single inlet 86 and the plurality of outlets 88. The air discharge passage 84 may be bent between the plurality of outlets 88 and the branch point 87. The second plug 94 may be disposed in the air discharge passage 84 between the plurality of outlets 88 and the branch point 87. When a length of the second plug 94 increases, a probability of a leakage of the electrolyte 70 may be reduced.

Accordingly, the dye-sensitized solar cell of FIG. 3 may increase in a life. In the first example, lengths of the air discharge passage 84 and the second plug 94 between the single inlet 86 and the plurality of outlets 88 more increase than the embodiment of FIG. 1.

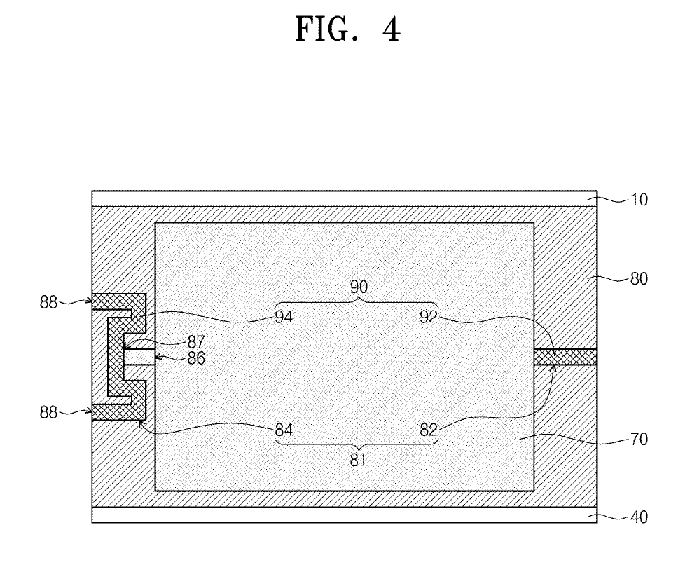

FIG. 4 is a top view of a dye-sensitized solar cell according to a second example of the embodiment.

Referring to FIG. 4, the dye-sensitized solar cell may include the sealing member 80 including the air discharge passage 84 having an arrow shape. The plurality of outlets 88 may be disposed near both edges of the lower substrate 10 and the upper substrate 40. The air discharge passage 84 between the plurality of outlets 88 and the branch point 87 may be bent several times. The air discharge passage 84 having the arrow shape may increase a length of the second plug 94. In the second example, the air discharge passage 84 is disposed as the arrow shape.

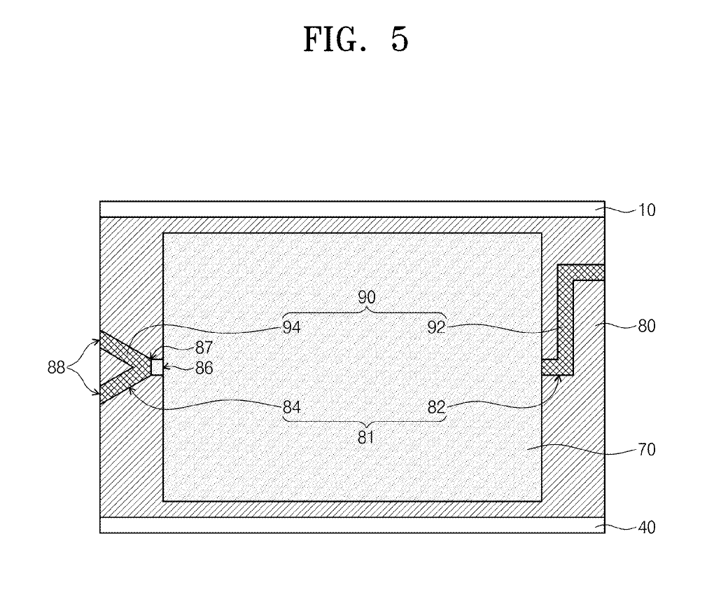

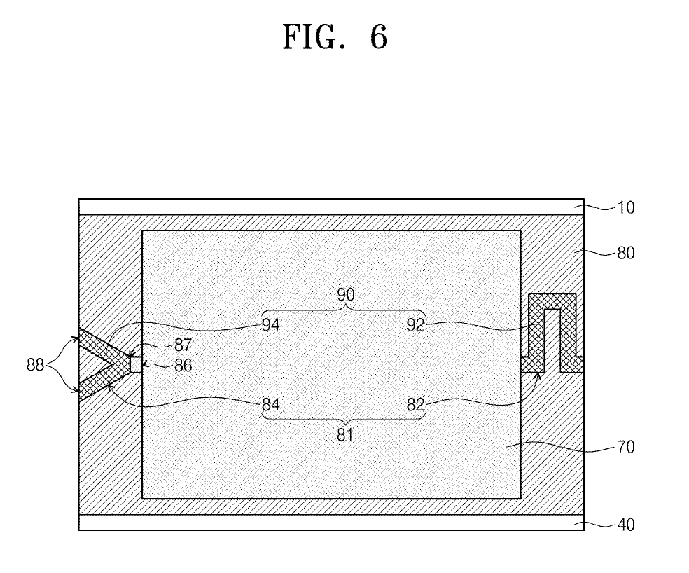

FIGS. 5 and 6 are top views of dye-sensitized solar cells according to third and fourth examples of the embodiment.

Referring to FIGS. 5 and 6, the dye-sensitized solar cells according to the third and fourth examples may include the fluid injection path 82, which is bent. The fluid injection path 82 may be turned once, twice, three times and more than that. The fluid injection path 82 may be bent as one of [symbol] , [symbol] , [symbol] , and a mixture or repetition thereof. The bent fluid injection path 82 may increase a length of the first plug 92 in the sealing member 80. When the length of the first plug 92 increases, durability and a life of the dye-sensitized solar cell may increase. In the fourth and fifth examples, the fluid injection path 82 is bent.

A method of manufacturing the dye-sensitized solar cell according to the embodiment, configured as described above, will be described as follows.

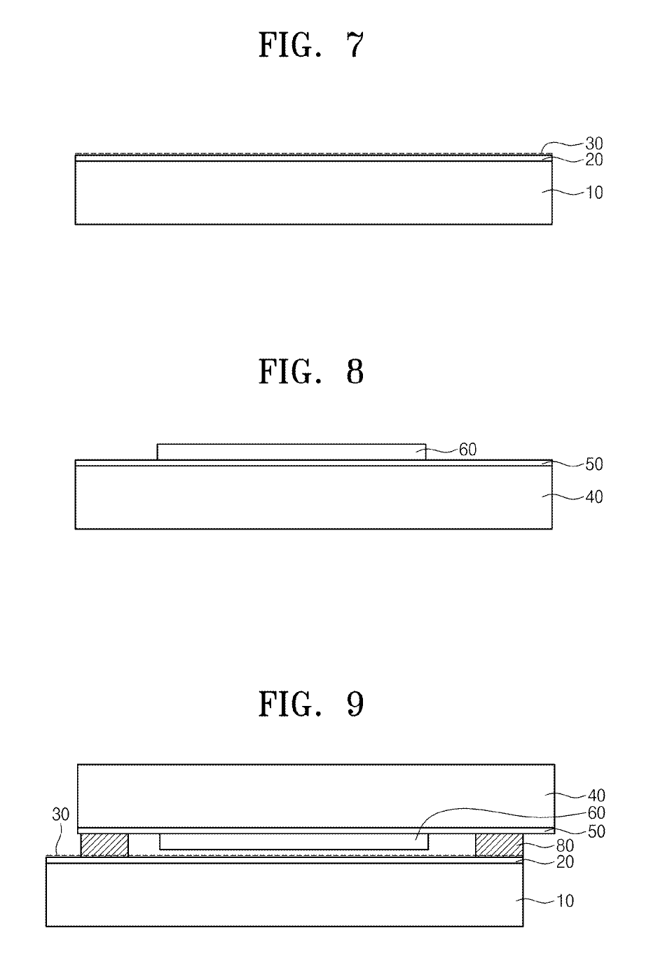

FIGS. 7 to 12 are cross-sectional views and top views sequentially illustrating the method of manufacturing the dye-sensitized solar cell according to the embodiment.

Referring to FIG. 7, the lower electrode 20 and the catalytic layer 30 are formed on the lower substrate 10.

Referring to FIG. 8, the upper electrode 50 and the catalytic layer 60 are formed on the upper substrate 40.

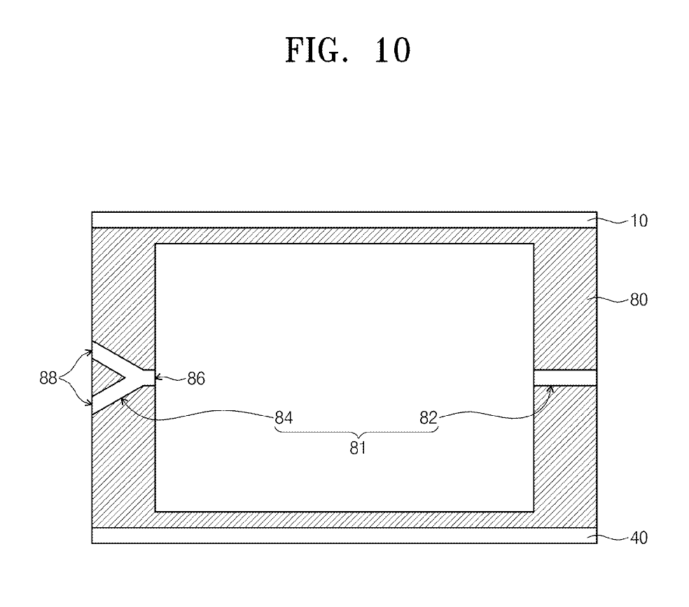

Referring to FIGS. 9 and 10, the sealing member 80 is formed on the edge of one of the lower substrate 10 and the upper substrate 40 and then the lower substrate 10 is bonded to the upper substrate 40. The sealing member 80 may include glass frit.

The sealing member 80 may be formed with the openings 81. The openings 81 may include the fluid injection path 82 and the air discharge passage 84. The fluid injection path 82 is a path for injecting the electrolyte 70. The air discharge passage 84 is a passage for discharging the air between the lower substrate 10 and the upper substrate 40 while injecting the electrolyte 70. The air discharge passage 84 may have a Y shape. The air discharge passage 84 may include the single inlet 86 and the plurality of outlets 88.

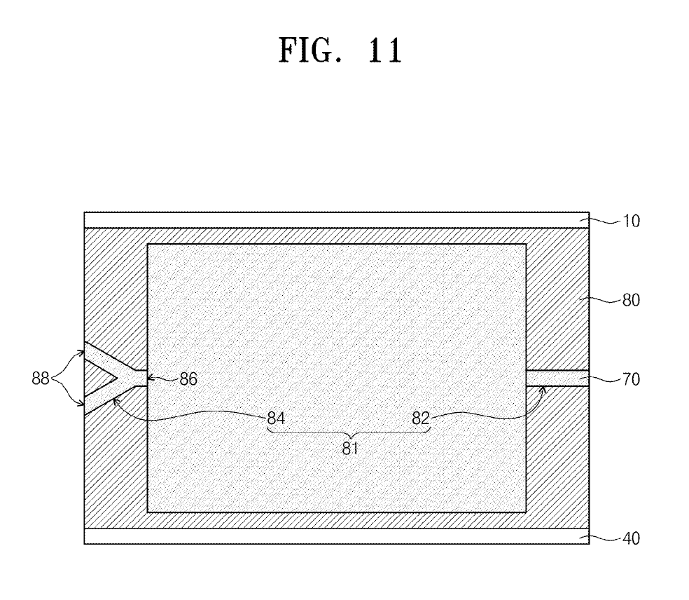

Referring to FIG. 11, the electrolyte 70 is injected into between the lower substrate 10 and the upper substrate 40. The electrolyte 70 may be provided with pressure higher than atmospheric pressure through the fluid injection path 82 while being injected. Also, the air discharge passage 84 may be provided with vacuum pressure lower than atmospheric pressure. An inside of the air discharge passage 84 may be filled with the electrolyte 70. Accordingly, residual bubbles between the lower substrate 10 and the upper substrate 40 may be minimized.

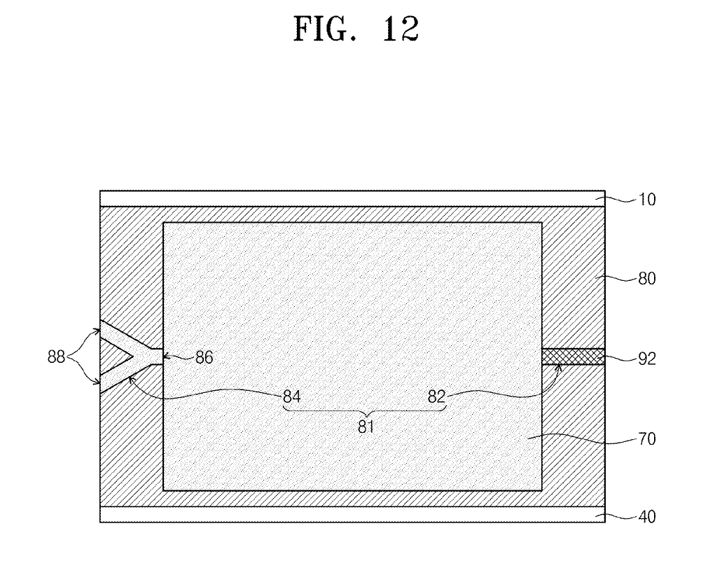

Referring to FIG. 12, the first plug 92 is formed in the fluid injection path 82. Herein, the electrolyte 70 may be partially discharged through the air discharge passage 84. The first plug 92 may prevent a leakage of the electrolyte 70 from the fluid injection path 82. The first plug 92 may include epoxy resin. The first plug 92 may be cured in the fluid injection path 82.

Referring to FIG. 1, the second plug 94 is formed in the air discharge passage 84. The second plug 94 may be injected into one of the plurality of outlets 88 and may be discharged through another thereof.

The second plug 94 may be provided to one of the plurality of outlets 88 with pressure higher than atmospheric pressure. Another of the plurality of outlets 88 may be provided with vacuum pressure lower than atmospheric pressure. Accordingly, the second plug 94 may be formed in the air discharge passage 84 between the plurality of outlets 88. The second plug 94 may include epoxy resin. The second plug 94 may be cured in the air discharge passage 84. While injecting the second plug 94, the electrolyte 70 between the lower substrate 10 and the upper substrate 40 is not provided with pressure. Accordingly, deformation or damages of the lower substrate 10, the upper substrate 40, and the sealing member 80, caused by pressure, may be prevented.

Accordingly, the dye-sensitized solar cell according to the embodiment may improve in durability, productivity, and production yield.

As described above, the dye-sensitized solar cell according to the embodiments may include a sealing member between an upper substrate and a lower substrate. The sealing member may include a fluid injection path and an air discharge passage. When an injection of an electrolyte is completed, a first plug may be formed in the fluid injection path. The air discharge passage may include one inlet and a plurality of outlets and may have a cap shape. When a second plug is injected into one of the outlets, the second plug may be discharged through another of the outlets. Since the second plug is formed to be linear through the plurality outlets, excessive pressure formed inside the solar cell, which causes damage, may be prevented. The dye-sensitized solar cell and a method of manufacturing the same according to the embodiment may improve productivity and production yield.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A dye-sensitized solar cell comprising:
a lower substrate;
an upper substrate opposite to the lower substrate;
an electrolyte between the upper substrate and the lower substrate;
a sealing member surrounding edges of the upper substrate and the lower substrate and comprising a plurality of openings that the electrolyte is provided in a space between the upper substrate and the lower substrate; and
a plurality of plugs inserted in the openings,
wherein the openings comprise:
at least one fluid injection path disposed at a first side of the upper substrate and the lower substrate; and
an air discharge passage disposed at a second side of the upper substrate and the lower substrate opposite to the fluid injection path, the air discharge passage comprising at least one inlet formed on an inner wall of the sealing member, and a plurality of outlets branching off from the inlet in the sealing member, the plurality of outlets formed on an outer wall of the sealing member.

2. The dye-sensitized solar cell of claim 1, wherein the air discharge passage has a Y shape.

3. The dye-sensitized solar cell of claim 2, wherein the plugs comprise:
a first plug disposed in the fluid injection path; and
a second plug disposed in the air discharge passage.

4. The dye-sensitized solar cell of claim 3, wherein the second plug connects one to another of the plurality of outlets of the air discharge passage having the Y shape.

5. The dye-sensitized solar cell of claim 3, wherein the second plug has a V shape.

6. The dye-sensitized solar cell of claim 2, wherein the electrolyte is disposed from the inlet to a branch point of the air discharge passage having the Y shape.

7. The dye-sensitized solar cell of claim 6, wherein the air discharge passage from the plurality of outlets to the branch point is bent.

8. The dye-sensitized solar cell of claim 1, wherein the plurality of outlets are disposed near one of the edges of the upper substrate and the lower substrate, and the inlet is disposed near another of the edges of the upper substrate and the lower substrate.

9. The dye-sensitized solar cell of claim 1, wherein the air discharge passage between the plurality of outlets is bent as an arrow.

10. The dye-sensitized solar cell of claim 1, wherein the plurality of outlets are disposed near both edges of the upper substrate and the lower substrate, respectively.

11. The dye-sensitized solar cell of claim 1, wherein the plurality of plugs are connected in the air discharge passage between the plurality of outlets.

12. The dye-sensitized solar cell of claim 1, wherein the fluid injection path is bent once, twice, three times and more than that.

13. A method of manufacturing a dye-sensitized solar cell, comprising:
forming a lower electrode on a lower substrate;
forming an upper electrode on an upper substrate opposite to the lower substrate;
forming a sealing member comprising a fluid injection path and an air discharge passage on edges of the upper substrate and the lower substrate to bond the upper substrate to the lower substrate;
providing a fluid comprising dye and an electrolyte in a space between the upper substrate and the lower substrate; and
forming a first plug and a second plug in the fluid injection path and the air discharge passage, respectively,
wherein the air discharge passage comprises at least one inlet formed on an inner wall of the sealing member and a plurality of outlets branching off from the inlet in the sealing member, the plurality of outlets formed on an outer wall of the sealing member, and
wherein the second plug is injected from one to another of the plurality of outlets.

14. The method of claim 13, wherein the first plug and the second plug comprise epoxy resin, and
wherein the second plug is provided to the air discharge passage after the first plug is cured.
